(19) United States
(12) Patent Application Publication
(10) Pub. No.: US 2020/0356297 A1
(43) Pub. Date: Nov. 12, 2020

(54) METHOD OF STORAGE CONTROL BASED ON LOG DATA TYPES

(71) Applicant: Hitachi, Ltd., Tokyo (JP)

(72) Inventors: Miho KOBAYASHI, San Jose, CA (US); Hideo SAITO, Kanagawa (JP)

(73) Assignee: Hitachi, Ltd.

(21) Appl. No.: 16/409,604

(22) Filed: May 10, 2019

(51) Int. Cl. G06F 3/06; G06F 11/34

(52) U.S. Cl. CPC G06F 3/0647; G06F 11/3476; G06F 2201/81; G06F 3/0605; G06F 3/0685; G06F 3/0656

(57) ABSTRACT

Example implementations described herein are directed to systems and methods to manage log data that is stored to a storage system. In example implementations, received log data is classified for storage into a storage system having a high tier storage and a low tier storage. For the classification indicative of storage into the high tier storage of the storage system, the storage system stores the log data into the high tier storage, and moves related log data stored in the low tier storage to the high tier storage. For the classification indicative of storage into the low tier storage of the storage system, the storage system stores the log data into the low tier storage and moves the related log data stored in the high tier storage to the low tier storage.

### BACKGROUND

### Field

The present disclosure is generally directed to storage systems, and more specifically, to storage control based on log data.

### Related Art

The number of companies that hold and analyze a large amount of log data of services for customers has increased. Since such companies desire to keep as much log data as possible to obtain high analytical accuracy, they take various countermeasures to suppress the retention cost of log data; for instance, by moving old log data to cheap and low speed devices, or though data compression of old log data.

However, as the content of the analysis changes frequently, there is difficulty in migrating and compressing log data without degrading analysis performance. In other words, the analysis performance may be degraded if there is no consideration regarding which logs are analyzed. Furthermore, manually designating log data to be moved/compressed based on this consideration is complicated, and there can be difficulty to keep up with the change of analysis contents.

In the related art, there is a system management unit which plans data migration according to a computation job execution schedule. In such a related art implementation, the system management unit creates a computation job execution schedule for a plurality of the computing units or obtains the computation job execution schedule from other unit in the computing system, plans a data migration in the tiered storage unit according to the execution schedule using a predetermined method, and instructs the tiered storage unit to migrate a data based on the plan.

### SUMMARY

However, in the related art, there is no differentiation between log data based on access characteristics. Example implementations described herein are directed to a storage system that performs moving/compression of log data focusing on the fact that the access characteristics are different for each log data type. Data movement and compression between storage tiers are performed on the storage in example implementations described herein, based on the access frequency for each log data type.

Aspects of the present disclosure involve a method, which can include classifying received log data for storage into a storage system involving a high tier storage and a low tier storage; for the classification indicative of storage into the high tier storage of the storage system, storing the log data into the high tier storage, and moving related log data stored in the low tier storage to the high tier storage; and for the classification indicative of storage into the low tier storage of the storage system, storing the log data into the low tier storage and moving the related log data stored in the high tier storage to the low tier storage.

Aspects of the present disclosure involve a computer program, storing instructions which can involve include classifying received log data for storage into a storage system involving a high tier storage and a low tier storage; for the classification indicative of storage into the high tier storage of the storage system, storing the log data into the high tier storage, and moving related log data stored in the low tier storage to the high tier storage; and for the classification indicative of storage into the low tier storage of the storage system, storing the log data into the low tier storage and moving the related log data stored in the high tier storage to the low tier storage. The instructions can be stored in a non-transitory computer readable medium and configured to be executed by one or more processors.

Aspects of the present disclosure further involve a server configured to manage a storage system involving high tier storage and low tier storage, the server involving a processor, configured to classify received log data for storage into a storage system; for the classification indicative of storage into the high tier storage of the storage system, store the log data into the high tier storage, and move related log data stored in the low tier storage to the high tier storage; and for the classification indicative of storage into the low tier storage of the storage system, store the log data into the low tier storage and move the related log data stored in the high tier storage to the low tier storage.

Aspects of the present disclosure involve a system, which can include means for classifying received log data for storage into a storage system involving a high tier storage and a low tier storage; for the classification indicative of storage into the high tier storage of the storage system, means for storing the log data into the high tier storage, and moving related log data stored in the low tier storage to the high tier storage; and for the classification indicative of storage into the low tier storage of the storage system, means for storing the log data into the low tier storage and moving the related log data stored in the high tier storage to the low tier storage.

### BRIEF DESCRIPTION OF DRAWINGS

FIG. 1 illustrates an example overall system, in accordance with an example implementation.

FIG. 2 illustrates an example of a logical configuration of the system in which the method and apparatus of the example implementations described herein may be applied.

FIG. 3 illustrates an example memory configuration in the log data generator server, in accordance with an example implementation.

FIG. 4 illustrates the configurations of the management area in the storage system, in accordance with an example implementation.

FIG. 5 illustrates the process of classifying the log type for the first time, in accordance with an example implementation.

FIG. 6 illustrates an example process for accessing log data, in accordance with an example implementation.

FIG. 7 illustrates the process of storing new log data after classification of log data, in accordance with an example implementation.

FIG. 8 illustrates a process for moving log data, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In a first example implementation, there is a log data generator server that creates a Generated Log Data Table, determines how log data are classified and further determines how a storage system determines a storage tier for stored data and so on.

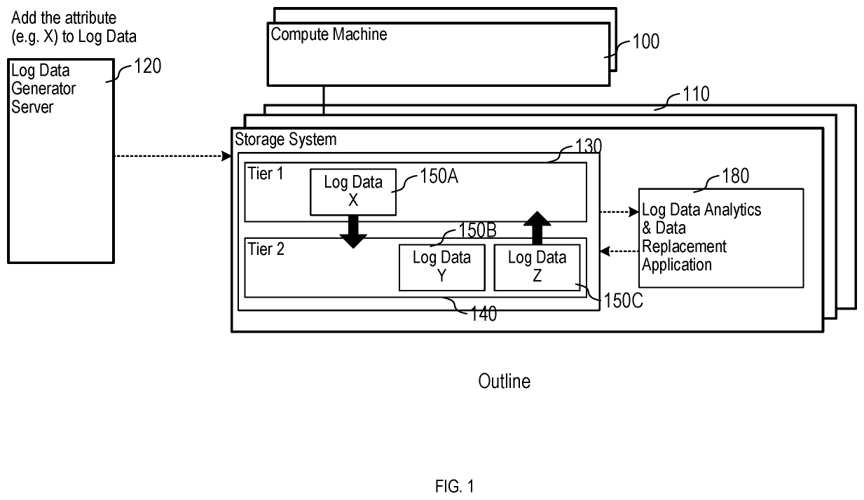

FIG. 1 illustrates an example overall system, in accordance with an example implementation. One or more compute machines 100 are connected to storage system 110 and the compute machines 100 can have an analysis application running. For the analysis application, log data generator server 120 generates log data 150, assigns attributes to each log data, and stores them to storage system 110. In storage system 110, there are two types of devices, Tier 1 (high speed but expensive) 130 and Tier 2 (low speed and low cost) 140, and there can also be a log data analytics & data replacement application 180. This application 180 monitors an access frequency of the log data and moves the log data to an appropriate tier after a certain time as set by a user.

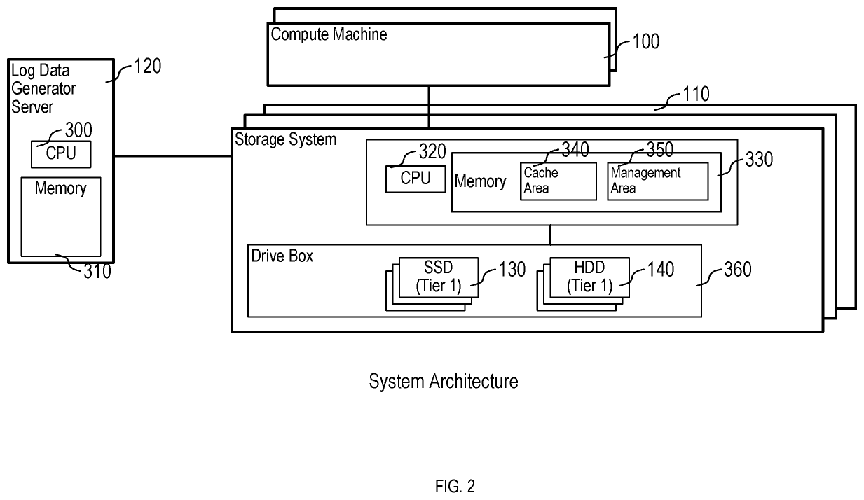

FIG. 2 illustrates an example of a logical configuration of the system in which the method and apparatus of the example implementations described herein may be applied. Compute machines 100 and the log data generator server 120 are connected to storage system 110. There are one or more central processing units (CPUs) 300 and memories 310 in log data generator server 120. Further, storage system 110 can include controllers and drive boxes 360. In drive boxes 360, there are two types of devices, for instance, solid state drives (SSD) for tier 1 130 and hard disk drive (HDD) for tier 2 140. A controller can include CPU 320 and memory 330, wherein memory 330 can involve a cache area 340 and management area 350.

Storage system 110 may also involve storage nodes. Further, the number of tiers may be other than two in accordance with a desired implementation. Also, the server may be a virtual machine or be one of the compute engines depending on the desired implementation. The log generator function may also be in the storage system 110 in accordance with a desired implementation. Further, there may be more than one log data generator servers 120, in accordance with a desired implementation.

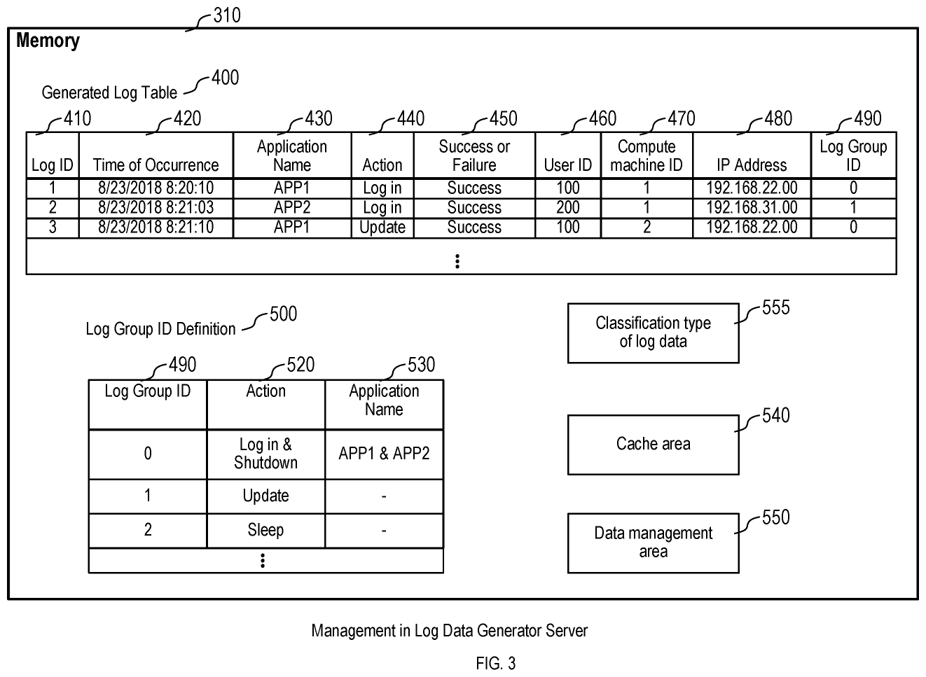

FIG. 3 illustrates an example configuration of memory 310 in the log data generator server 120, in accordance with an example implementation. Specifically, there is cache area 540, data management area 550 and log data management area in memory 330. The log data management area can involve generated log table 400, log group identifier (ID) definition 500 and classification type of log data 555. When new log data is generated, the information of the new log data is added in generated log table 400. If classification of log data has not been conducted, log group ID 490 is left blank. Log group ID 490 includes the attributes of the log data which the user can define or which can be generated automatically by log data generator server 120.

The generated log table 400 can involve several columns for the entries. Column 410 shows log IDs. Column 420 shows time of occurrence. Column 430 shows application names. Column 440 shows action types. Column 450 shows success or failure of the action. Column 460 shows user IDs. Column 470 shows the compute machine ID that conducts the action. Column 480 shows IP address of the compute machine. Column 490 shows log group ID.

Log group ID definition 500 is a table for managing log data types and the elements included in this table depends on how a user would like to classify log data. For instance, the log group ID definition 500 can include log group ID 490, action type of log data 520 and application name 530, as example implementations can analyze the contents of the log data and merge log data of similar applications as one group in accordance with the desired implementation. Alternatively, log data can be of different types for each log data generator server or for each group of log data generator servers depending on the desired implementation.

Classification type of log data 555 shows a selected log data classification type. Some classification types are showed, and a user may select one of them or a log data generator server 120 may propose one of them to a user or log data generator server 120 may choose one of them automatically.

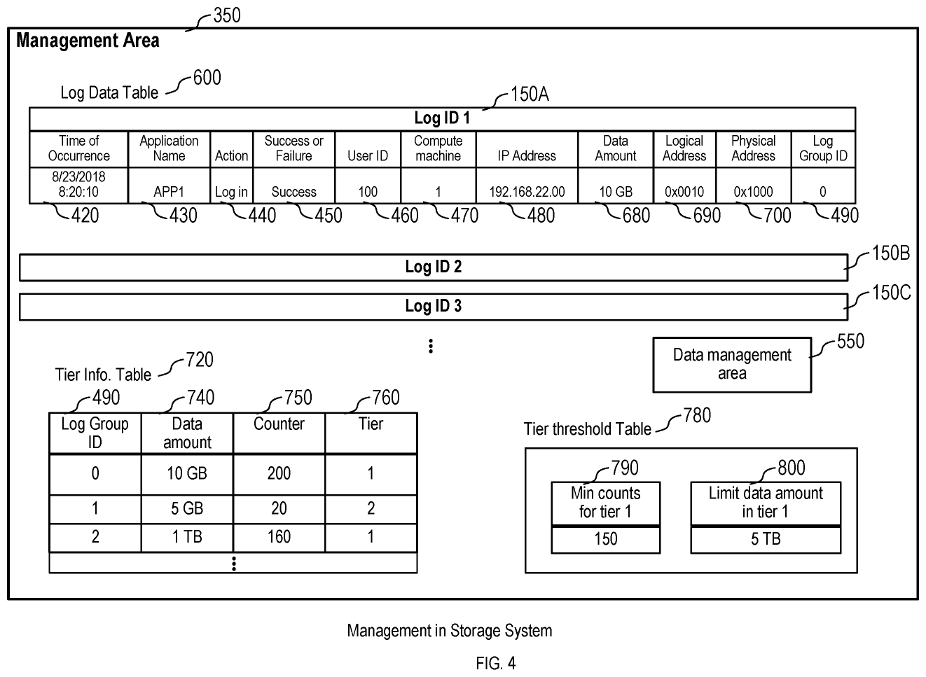

FIG. 4 illustrates the configurations of management area 350 in storage system 110, in accordance with an example implementation. Data management area 550 is an area for managing file data storage address and the like, and does not include log data related management information. In log data management area, there is a log data table 600, tier information table 720 and tier threshold table 780. Log data table 600 involves one or more entries for log ID information 150A, 150B, 150C and each entry is stored in tier 1 or tier 2. Each log ID information 150A, 150B, 150C includes the information of the generated log table 600. Column 680 shows the data amount of the log ID. Column 690 shows the logical address for stored data in a storage system. Column 700 shows the physical address for the stored data in a storage system.

Tier information table 720 manages where log group IDs 490 are stored, and in which tiers. This table 720 can include the log group ID 490, total data amount of a log group ID 740, access counter 750 and tier 760. Depending on the desired implementation, access counter 740 may be further broken down to a counter for read operations and a counter for write operations from compute nodes, in accordance with the desired implementation.

Tier threshold table 780 manages tier threshold information to determine the moving data between tier 1 and tier 2. This table 780 involves minimum counts for tier 1 790 and limit data amount in tier 1 800.

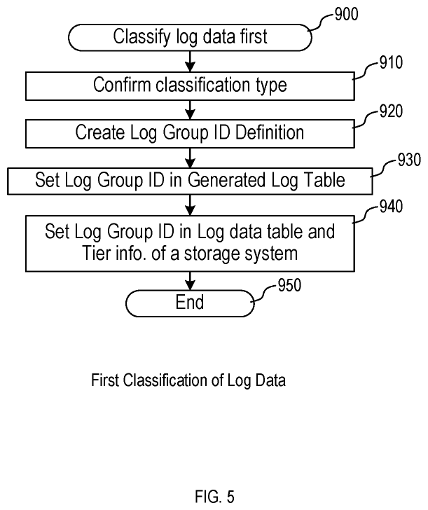

FIG. 5 illustrates the process of classifying the log type for the first time, in accordance with an example implementation. In order to classify the log data type, it is necessary to gather information on the access characteristics for the log data initially, whereupon after a certain period of time elapses, the first classification processing is then performed. The process for FIG. 5 is executed only for the first time for classifying a log data type. Depending on the classification method of the log data type, it may not be necessary to wait for the certain period of time to elapse, and log group ID definition 550 may also be created from the beginning. The process begins at 900 when the process is invoked by the storage system 110 through the log data analytics and data replacement application 180.

At 910, the log data generator server 120 confirms the classification type of the log data. If no type of log data is selected, the log data generator server 120 suggests the optimal one for a user, or can conduct a selection in accordance with the desired implementation. At 920, the log data generator server 120 creates the log group ID definition based on the classification type. At 930, the log data generator server 120 sets log group ID 490 for each log ID 410 in generated log table 400 based on the information of log group ID definition 500. At 940, the log data generator server 120 sends the information of the log data with log group IDs to the storage system 110. Then, the storage system 110 sets log group ID 490 for each log ID 150A, 150B, 150C, in log data table 600 and sets log group ID 490 in tier information table 760. Elements other than log group ID 490 is blank in tier information table 720. Storage system 110 may set the default to tier 2 for all group IDs or may automatically determine tiers for group IDs depending on the desired implementation. Once conducted, the process ends at 950.

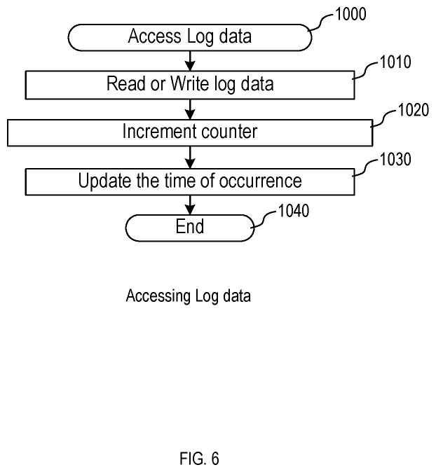

FIG. 6 illustrates an example process 1000 for accessing log data, in accordance with an example implementation. When compute machines 100 access log data 150A, 150B, 150C in storage system 110 at 1010, it is necessary to confirm the log group ID 450 of the log data in log data table 600 and increment the corresponding counter in tier information table 750 at 1020. At 1030, storage system 110 updates the time of occurrence 420 in the corresponding log ID table 150A, 150B, 150C, and the process ends at 1040.

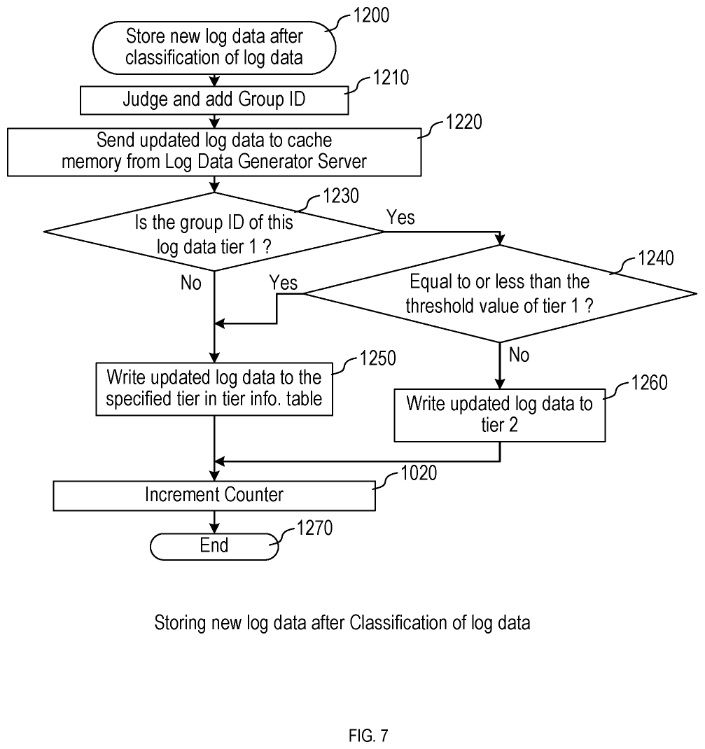

FIG. 7 illustrates the process 1200 of storing new log data after classification of log data, in accordance with an example implementation.

In example implementations, the table can be created in advance manually. If new log data is generated by log data generator server 120, the server should determine the classification type of the new log data.

At 1210, the log data generator server 120 determines the classification type of this log data based on log group ID definition 500 and decide a log group ID for it. Then the server sets the information of this log data in generated log table 400. At 1220, the log data generator server 120 then sends updated log data information to the cache area 340 of the storage system 110.

At 1230, the storage system 110 confirms the group ID of this log data and determines the tier to store the log data based on tier information table 720. If the tier for the log data is tier 1 (Yes), then the process proceeds to 1240, otherwise (No), the process proceeds to 1250.

At 1240, the storage system 110 confirms the tier 1 status based on tier threshold table 780. If the tier 1 status is equal to or less than the threshold value of tier 1 (Yes), the process proceeds to 1250. Otherwise, if the tier 1 status is over than the threshold value of tier 1 (No), the process proceeds to 1260.

At 1250, the storage system 110 writes updated log data to the specified tier based on the tier information table 720 and updates the logical address 690/physical address 700 in the log data table 600. At 1260, the storage system 110 writes updated log data to tier 2 and updates logical address 690/physical address 700 in log data table 600.

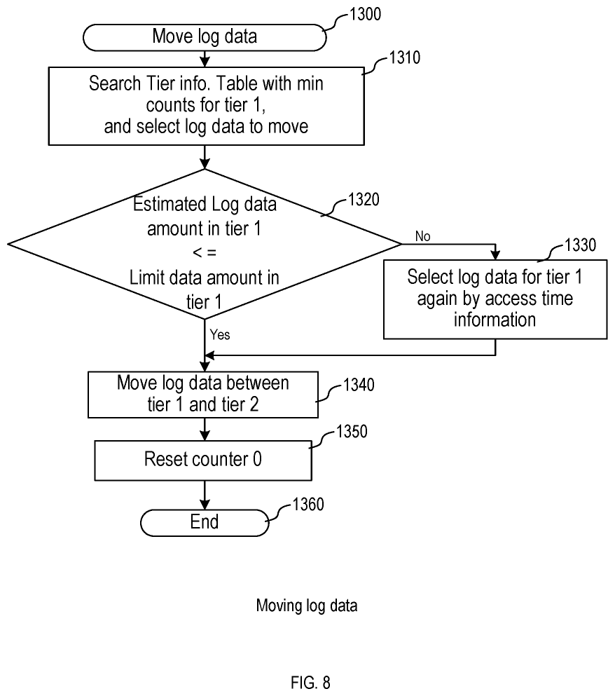

FIG. 8 illustrates a process 1300 for moving log data, in accordance with an example implementation. The storage system 110 moves log data whose access time is new among frequently accessed ones to upper layers. The log data movement frequency may be decided by the user or by storage system.

At 1310, the storage system 110 searches the tier information table 720 with minimum counts for tier 1 790 and selects log data for moving to another tier.

At 1320, the storage system 110 determines whether the estimated log data amount in tier 1 is equal or less than the limit data amount in tier 1 730 or not. If the answer is yes, the process proceeds to 1340. If the answer is no, the process proceeds to 1330.

At 1330, the storage system 110 selects log data for tier 1 storage by using the time of occurrence 420 information. The storage system 110 sequentially selects the log data to remain in tier 1 storage until the threshold value of tier 1 storage capacity is reached, starting with the log data having the earlier access time.

At 1340, the storage system 110 moves the log data between tier 1 and tier 2 as applicable.

At 1350, the storage system 110 resets the all counters 750 in tier information table 720 to zeros. The storage system 110 may compresses log data that was selected for tier 2 storage from the beginning and stores the compressed log data in tier 2 storage.

As described herein, there is a storage system that has high tier storage (tier 1), and low tier storage (tier 2) as described in FIG. 2. Storage system can be configured to, through execution of log data analytics and data replacement application 180 by CPU 320 as illustrated in FIG. 1 and FIG. 2, classify received log data through receipt of the log group ID of the log and comparing it with tier information table 720 to determine the tier. For the classification indicative of storage into the high tier storage of the storage system, the storage system is configured to store the log data into the high tier storage, and move related log data stored in the low tier storage to the high tier storage; and for the classification indicative of storage into the low tier storage of the storage system, storing the log data into the low tier storage and moving the related log data stored in the high tier storage to the low tier storage through the execution of the flow diagram of FIG. 7.

In example implementations, the storage system 110 can be configured to, through execution of log data analytics and data replacement application 180 by CPU 320 as illustrated in FIG. 1 and FIG. 2, move the related log data based on an access frequency, when the log data is accessed, classify other first log data stored in the high tier storage of the storage system and other second log data stored in the low tier storage of the storage system; for the classification of the other first log data indicative of storage into the low tier storage of the storage system, move the other first log data into the low tier storage; and for the classification of the other second log data indicative of storage into the high tier storage of the storage system, move the other second log data into the high tier storage as illustrated in FIG. 8.

In example implementations, the classification of the log ID can be conducted according to one or more of an application, an action, or a compute machine associated with the log data as set by log group ID definition 500 of FIG. 3 by the log data generator server 120. Similarly, the classification can be conducted according to the application associated with the log data based on a grouping of log data based on the application, and an access frequency associated with the grouping of the log data based on the determined log group ID from log group ID definition 500, and utilizing the log group ID in reference to tier information table 720 as compared to a counter 750 and a tier threshold table 780 indicating the minimum access required for keeping the log data in high tier storage 790 by storage system 110. For example, if the log group ID associated with the application has an access frequency exceeding an access threshold for the high tier storage, the storage system 110 classifies the received log data as being indicative of storage in the high tier storage which can be conducted through the flow diagram of FIG. 8.

Depending on the desired implementation, the access threshold can be defined through a user interface on the log data generator server 120. For example, the interface can be configured to change the value of the access threshold 790 of tier threshold table 780 through user input.

In example implementations, storage system 110 can be configured to, through execution of log data analytics and data replacement application 180 by CPU 320 as illustrated in FIG. 1 and FIG. 2, execute the flow diagram of FIG. 8 so that for an amount of the log data stored in the high tier storage exceeding a threshold amount of data for the high tier storage, the storage system 110 selects ones of the log data stored in the high tier storage to remain in the high tier storage based on recency of access based on the time of occurrence 420 in the log data 150A, 150B, 150C in log data table 600; and move remaining ones of the log data stored in the high tier storage to the low tier storage.

Depending on the desired implementation, storage system 110 can be configured to, through CPU 320, compress log data that is to be moved to or stored in low tier storage so as to save storage space for the log data. Similarly, when log data is moved from low tier storage to high tier storage, storage system 110 can be configured to, through CPU 320, decompress the log data to be moved from the low tier storage before moving the data to the high tier storage.

Through the example implementations described herein, there is a log data holding method for suppressing the holding cost to a company that holds a large amount of log data for customers and uses it for analysis. Tier management program for log data provides a user interface through which users can select the tier threshold values. Log data management program in log data generator server may provide a user interface which users can select a classification type of log data, if users can select it as a specification.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
classifying received log data for storage into a storage system comprising a high tier storage and a low tier storage;
for the classification indicative of storage into the high tier storage of the storage system, storing the log data into the high tier storage, and moving related log data stored in the low tier storage to the high tier storage; and
for the classification indicative of storage into the low tier storage of the storage system, storing the log data into the low tier storage and moving the related log data stored in the high tier storage to the low tier storage.

2. The method of claim 1, wherein the moving the related log data is conducted based on an access frequency, wherein the method further comprises:
when the log data is accessed, classifying other first log data stored in the high tier storage of the storage system and other second log data stored in the low tier storage of the storage system;
for the classification of the other first log data indicative of storage into the low tier storage of the storage system, moving the other first log data into the low tier storage;
for the classification of the other second log data indicative of storage into the high tier storage of the storage system, moving the other second log data into the high tier storage.

3. The method of claim 1, wherein the classification is conducted according to one or more of an application, an action, or a compute machine associated with the log data.

4. The method of claim 3, wherein the classification is conducted according to the application associated with the log data based on a grouping of log data based on the application, and an access frequency associated with the grouping of the log data;
wherein for the application being associated with a grouping having an access frequency exceeding an access threshold for the high tier storage, classifying the received log data as being indicative of storage in the high tier storage.

5. The method of claim 4, wherein the access threshold is defined through a user interface on a server generating the log data.

6. The method of claim 1, further comprising:
for an amount of the log data stored in the high tier storage exceeding a threshold amount of data for the high tier storage:
selecting ones of the log data stored in the high tier storage to remain in the high tier storage based on recency of access; and
moving remaining ones of the log data stored in the high tier storage to the low tier storage.

7. The method of claim 1, further comprising, for the classification indicative of storage into a low tier storage of the storage system, compressing the received log data and storing the compressed log data into the low tier storage.

8. A non-transitory computer readable medium, storing instructions for executing a process, the instructions comprising:
classifying received log data for storage into a storage system comprising a high tier storage and a low tier storage;
for the classification indicative of storage into the high tier storage of the storage system, storing the log data into the high tier storage, and moving related log data stored in the low tier storage to the high tier storage; and
for the classification indicative of storage into the low tier storage of the storage system, storing the log data into the low tier storage and moving the related log data stored in the high tier storage to the low tier storage.

9. The non-transitory computer readable medium of claim 8, wherein the moving the related log data is conducted based on an access frequency, wherein the instructions further comprise:
when the log data is accessed, classifying other first log data stored in the high tier storage of the storage system and other second log data stored in the low tier storage of the storage system;
for the classification of the other first log data indicative of storage into the low tier storage of the storage system, moving the other first log data into the low tier storage; and
for the classification of the other second log data indicative of storage into the high tier storage of the storage system, moving the other second log data into the high tier storage.

10. The non-transitory computer readable medium of claim 8, wherein the classification is conducted according to one or more of an application, an action, or a compute machine associated with the log data.

11. The non-transitory computer readable medium of claim 10, wherein the classification is conducted according to the application associated with the log data based on a grouping of log data based on the application, and an access frequency associated with the grouping of the log data;
wherein for the application being associated with a grouping having an access frequency exceeding an access threshold for the high tier storage, classifying the received log data as being indicative of storage in the high tier storage.

12. The non-transitory computer readable medium of claim 11, wherein the access threshold is defined through a user interface on a server generating the log data.

13. The non-transitory computer readable medium of claim 8, the instructions further comprising:
for an amount of the log data stored in the high tier storage exceeding a threshold amount of data for the high tier storage:
selecting ones of the log data stored in the high tier storage to remain in the high tier storage based on recency of access; and
moving remaining ones of the log data stored in the high tier storage to the low tier storage.

14. The non-transitory computer readable medium of claim 8, the instructions further comprising, for the classification indicative of storage into a low tier storage of the storage system, compressing the received log data and storing the compressed log data into the low tier storage.

15. A storage system, comprising:
high tier storage;
low tier storage; and
a processor, configured to:
classify received log data;
for the classification indicative of storage into the high tier storage of the storage system, store the log data into the high tier storage, and move related log data stored in the low tier storage to the high tier storage;
for the classification indicative of storage into the low tier storage of the storage system, store the log data into the low tier storage and move the related log data stored in the high tier storage to the low tier storage.
